(19) United States
(12) Patent Application Publication
(10) Pub. No.: US 2010/0038274 A1
(43) Pub. Date: Feb. 18, 2010

(54) Injection moulded clam shell container utilizing label as hinge element

(76) Inventor: Alexander Segal, Richmond Hill (CA)

Correspondence Address: Alex Porat, 445 Beverley Glen Blvd., Thornhill, ON, L4J 7S2, CA

(21) Appl. No.: 12/320,855

(22) Filed: Feb. 6, 2009

Related U.S. Application Data
(60) Provisional application No. 61/063,996, filed on Feb. 8, 2008.

(51) Int. Cl. B65D 1/34; B65D 21/00; B65D 85/00; B65D 43/16; B29C 45/14

(52) U.S. Cl. 206/505; 206/518; 206/524.6; 220/837; 264/46.4

(57) ABSTRACT

A clam shell type container having an injection moulded base, an injection moulded lid, and a web interconnecting the base and lid, wherein the web is formed from an in-mould label. The in-mould label is preferably deposited into a mould that simultaneously forms the base and lid, with the label being deposited into the mould prior to the injection of molten material. Upon formation, the label extends contiguously into the base and lid and becomes integrally adhered with the walls of the base and lid.

This Application claims the benefit of U.S. Provisional Application No. 61/063,996 filed Feb. 8, 2008.

### BACKGROUND OF INVENTION

Clam shell containers are a popular type of container for packaging food and other items, particularly restaurant or fast food. The clam shell type container is easy to stack, and easy to use, typically requiring the user to simply flip over the lid and push it to matingly engage with the base.

Typically, clam shell containers are manufactured from Styrofoam or polystyrene using well-known thermoforming or vacuum forming processes. However, such plastics are not environmentally friendly, and accordingly, their use is being phased out. These plastics are also not microwaveable or dish-washable. Furthermore, such containers are not leak proof and can dissolve with certain liquids commonly present in food such as oil, vinegar or alcohol.

Accordingly, it would be desirable to produce clam shell type containers using recyclable plastics. In particular, the invention seeks to provide a clam shell type container utilizing injection moulding processes, which can provide a high quality look and feel to the container, particularly if polypropylene is preferably employed.

### SUMMARY OF INVENTION

According to one aspect of the invention, there is provided a clam shell type container comprising an injection moulded base, an injection moulded lid that is moulded simultaneously with the base, and an interconnecting web between the base and lid that is integrally adhered to the base and lid during the moulding process, the web functioning as a hinge.

In the preferred embodiment, the interconnecting web is formed by an in-mold label. The in-mold label is a pre-manufactured thin film that is preformed to a desired shape and then deposited into the mould prior to commencement of an injection moulding cycle. The in-mold label is disposed so as to extend into and between the base and lid cavities. As the injection cycle commences, the base and lid are formed simultaneously in the same mould, and the portion of the in-mold label extending into the base and lid cavities integrally adheres with the base and lid. The portion of the in-mould label that extends between the base and lid cavities forms the interconnecting web or hinge of the clam shell container.

### BRIEF DESCRIPTION OF THE DRAWINGS

The invention will now be described, by way of example only, with reference to the attached Figures, wherein:

FIG. 1 is an exploded view of base, lid and interconnecting web components of a clam shell container according to a preferred embodiment;

FIGS. 2A and 2B are top and bottom perspective views, respectively, of the preferred embodiment in an open condition;

FIG. 3 is a perspective view of the preferred embodiment in a closed condition; and

FIG. 4 is a cross-sectional view of a portion of a mould cavity.

### DETAILED DESCRIPTION OF PREFERRED EMBODIMENTS

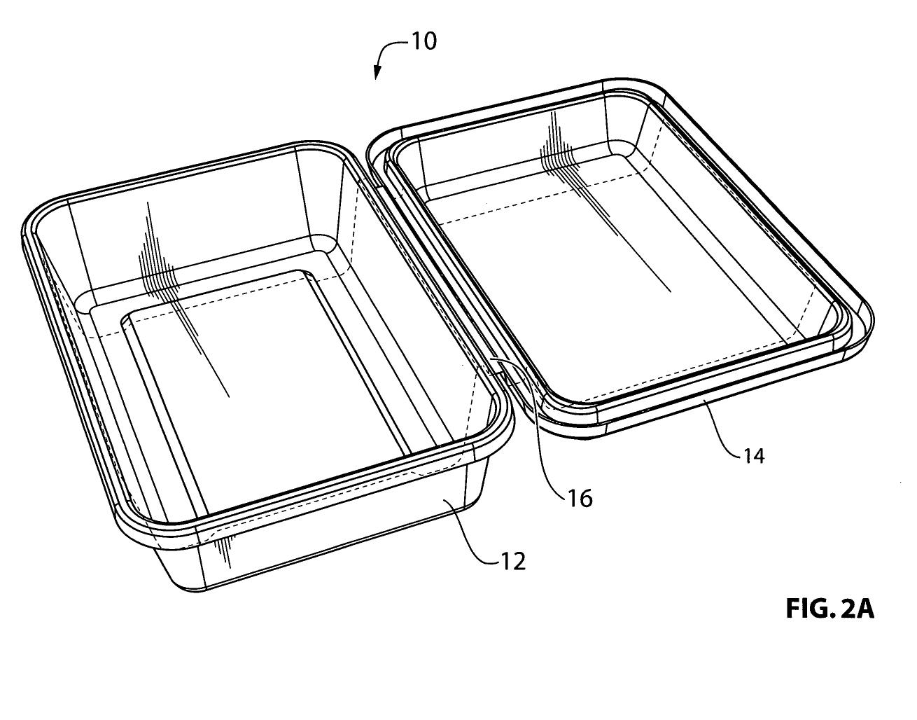

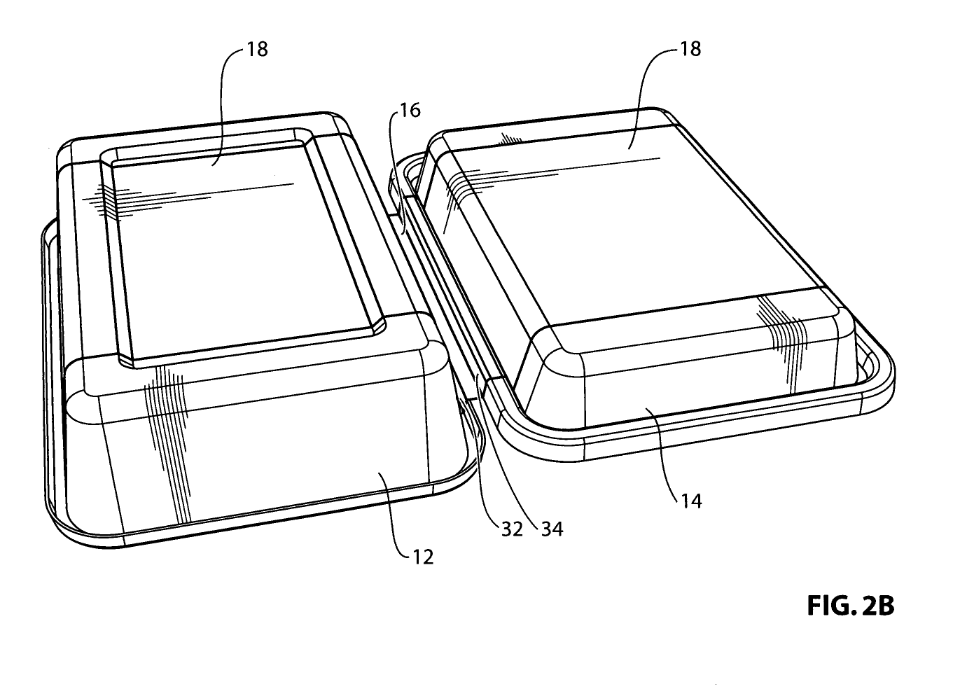

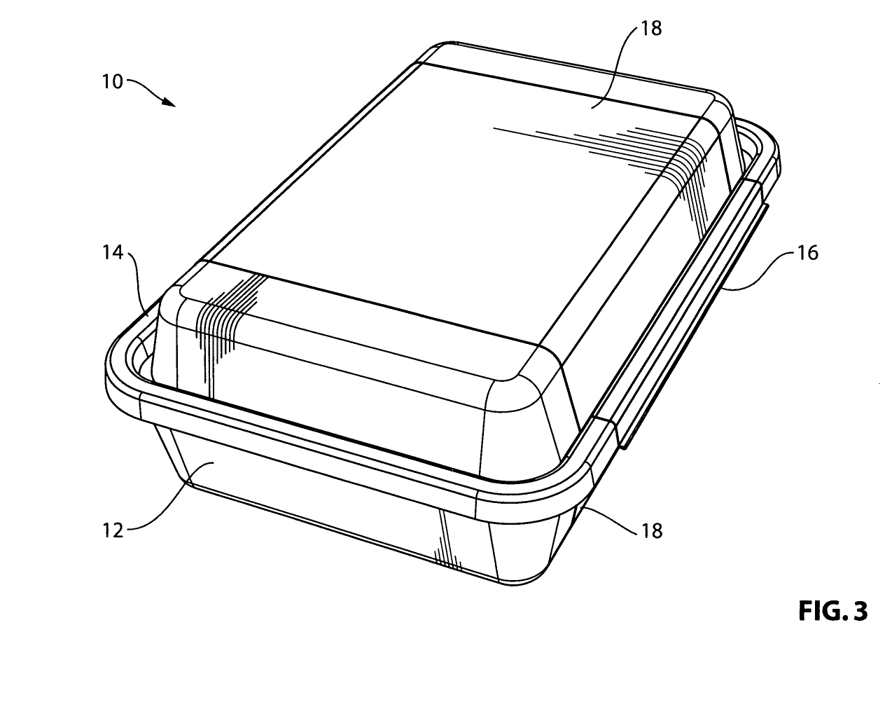

Referring to the drawings, particularly to FIG. 2A, the preferred embodiment is a polypropylene clam shell container 10 that includes a base 12, a lid 14, and a web 16 interconnecting the base and lid 12, 14.

The web 16 represents a portion of an in-mould label 18. As the base and lid are composed of polypropylene, the in-mould label 18 is preferably also formed from polypropylene so that it will integrally adhere with the base and lid components. In principle, however, it may be possible to utilize a different material such as other kinds of plastics or even fabric or paper.

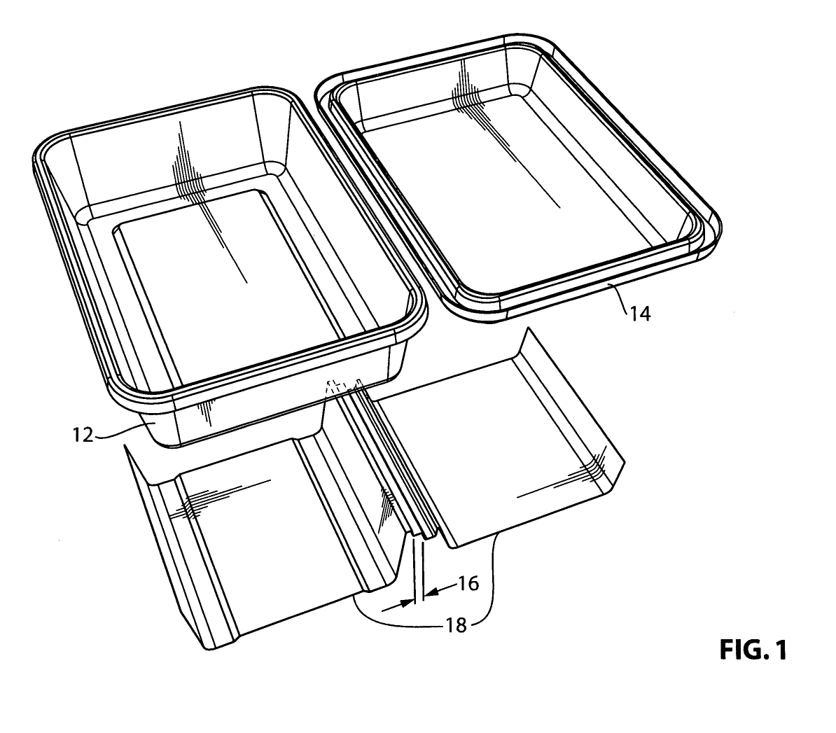

The in-mould-label 18, or appliqué, is a thin film having a thickness varying from about 0.001 to about 0.01 inches. In a known in-mold labeling manufacturing process, the label 18 is cut out from flat stock and picked up (or picked up from a stack or roll) by a robot arm (not shown) using vacuum pressure or electrostatic attraction. Depending on the complexity of the mould part, the label 18 may then be pre-shaped to a desired form, as shown in FIG. 1, by known mechanical operation such as stamping and die cutting. Prior to the injection cycle, the label 18 is deposited by the robot into the open mould and held in a desired position by vacuum ports, electrostatic attraction or other known methods. The mould closes and molten plastic resin is injected into the mould where it conforms to the shape of the mould, thus forming the clam shell container 10. The hot plastic envelopes the label 18, making it an integral part of the container 10. As opposed to a glue-applied label which only adheres on to the surface of a plastic product, the in-mold label is “in” the wall of the product, forming an integral part of it.

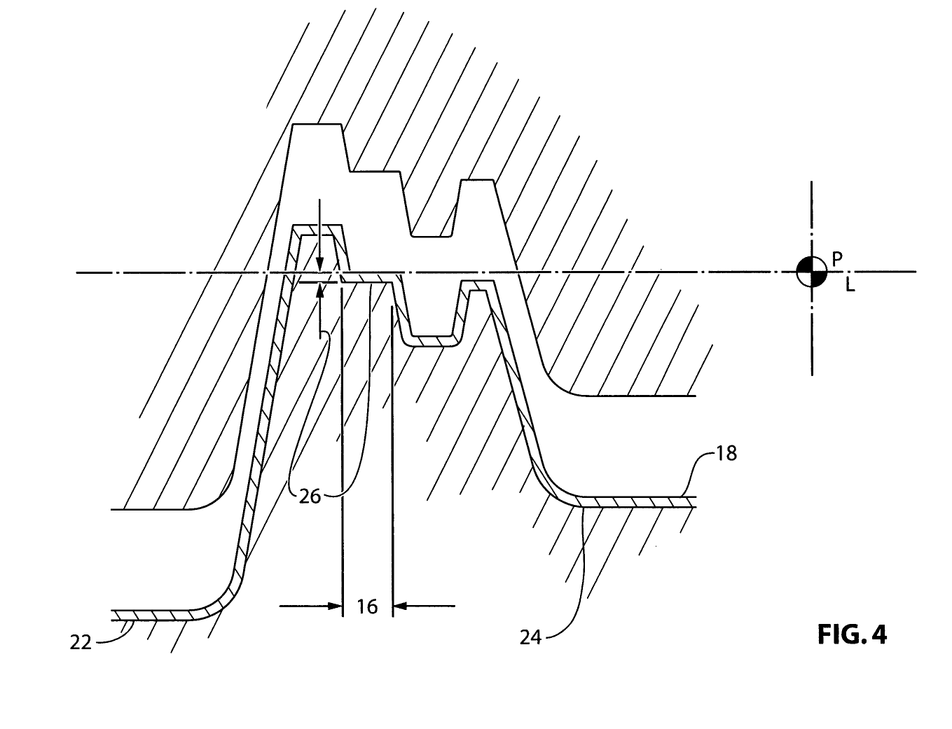

FIG. 4 shows a cross-sectional view of the cavity side of a mould 20. The mould 20 includes two cavities 22, 24. Cavity 22 is shaped to form the base 12, and cavity 24 is shaped to form the lid 14. Between the two cavities 22, 24, a thin recess or depression 26 is formed on the parting line surface of the mould which extends contiguously between the cavities 22, 24. The depth and width of depression 26 is sized to accept the label 18. The depth of the depression 26 corresponds to the thickness of the label, within a tolerance which will preclude molten material from flowing out of the cavities 22, 24. The label 18 also extends contiguously into both cavities 22, 24. During the injection moulding cycle, the portion of the label disposed within cavities 22, 24 is integrally embedded within the walls of the base and lid. However, the molten plastic or resin does not flow out of the cavities 22, 24. Thus, the portion of the label located in the depression 26 forms the interconnecting web 16 or hinge between the base 12 and lid 14.

In the preferred embodiment, as seen in FIG. 4, the label 18 extends substantially into the cavities 22, 24. However, in alternative embodiments it is possible to have a much shorter run into the cavities. For example, depending on the properties of the particular label employed, the label (see FIG. 2B) may only have to extend against a sidewall 30 of base 12 (which forms a part of a male seal element) and against a sidewall 34 of lid 14 (which forms a part of a female seal element).

Also, in the drawings, the label 18 is shown having a different colour than the base or lid. In practice, the label 18 can be printed with any desired text or graphics, and coloured as desired. Accordingly, upon manufacture the base and lid will display whatever is printed on the label 18. In the alternative, the label 18 may be formed from substantially the same colour and materials as the base and lid, and thus will be practically invisible to the end user.

In addition, in practice, the base and lid may be formed from the same material and thus use a single material injection moulding machine. Alternatively, a dual material injection moulding machine as known in the art per se may be employed wherein different materials, for example, a transparent polymer for a clear lid and a coloured polymer for an opaque base, are injected into the mould.

The above-described embodiments of the invention are intended to be examples of the invention and alterations and modifications may be effected thereto, by those of skill in the art, without departing from the spirit of the invention.

I claim:

1. A method of forming a clam shell type container having a base and interconnected lid, comprising:
providing an injection mould having at least a first cavity for forming the base, at least a second cavity for forming the lid, and a recess or depression extending between the base cavity and lid cavity;
opening the mould and depositing an in-mould label within the mould, wherein a portion of said label extends along said recess or depression and portions of said label extend into said base and lid cavities;
closing the mould and injecting material therein to simultaneously form said base and lid, wherein said label portions extending into said base and lid cavities are integrally adhered with the walls of said base and lid and said label portion extending along said recess or depression provides an interconnecting web between said base and lid; and
opening the mould after a sufficient cooling period and removing the container.

2. A method according to claim 1, wherein the size and thickness of said label and the corresponding size and depth of said recess or depression are selected so as to preclude molten material from flowing out of said base and lid cavities.

3. A clam shell type container, comprising an injection moulded base, an injection moulded lid, and a web interconnecting said base and lid, wherein said web is formed from an in-mould label.

4. The container according to claim 3, wherein the in-mould label is deposited into a mould that simultaneously forms the base and lid, the label being deposited prior to injection of molten material.

5. The container according to claim 4, wherein said label extends contiguously into said base and lid and is integrally adhered with the walls of said base and lid.
